(19) United States
(12) Patent Application Publication
(10) Pub. No.: US 2021/0334377 A1
(43) Pub. Date: Oct. 28, 2021

(54) METHOD FOR DYNAMICALLY ESTABLISHING A SECURE COMPUTING INFRASTRUCTURE

(71) Applicant: VMware, Inc., Palo Alto, CA (US)

(72) Inventors: Chen DRORI, Saratoga, CA (US); Michael A. FOLEY, Hubbardston, MA (US); Jesse POOL, Ottawa (CA); Nishant ARYA, San Ramon, CA (US)

(21) Appl. No.: 16/856,880

(22) Filed: Apr. 23, 2020

(51) Int. Cl. G06F 21/57; G06F 21/55; G06F 21/60

(52) U.S. Cl. CPC G06F 21/57; G06F 21/554; G06F 2221/2149; G06F 2221/034; G06F 21/606

(57) ABSTRACT

A method and system are disclosed in which a secure computing infrastructure is established and maintained. The method requires that upon any attestation event, a component to be added or newly activated (i.e., used the first time) be checked for its trustworthiness, where the checking includes cryptographic proof of the trustworthiness of the component. If the component is not trustworthy, then security precautions are taken to protect the secure computing infrastructure. Those precautions include refusing to accept the component, quarantining the component, encrypting and decrypting all traffic to and from the component, or allowing the component to perform only non-secure operations.

### BACKGROUND

Establishing and ensuring continued trustworthiness of a computing environment or data center includes encryption of data at rest, encryption of data in motion (e.g., during network communication), or setting up secure enclaves (e.g., memory encryption). However, these are all point-specific solutions and disjoint, and each has its own drawbacks. Other solutions have tried to address this issue via reactive solutions based on after-the-fact anomaly detection using analytics and positive pattern matching in order to detect compromised components and remove them.

One aspect of trust computing is that of assuring that the software state of a platform is not compromised. Proof of the software state can be provided using cryptography. Providing such proof can take several forms. One form includes a structure that includes a set of registers, each of which contains a hash of a current software module, and a hash of a selected set of those registers where the hash is signed using a key from an authentic source. With this form, any change in a software module is discoverable by recovering the hash of each software module and comparing the hash to an expected hash.

However, a platform includes many other components. It is desirable to ensure that all components of a platform are trustworthy.

### BRIEF DESCRIPTION OF THE DRAWINGS

FIG. 1 depicts components in a data center in which one or more embodiments may be implemented.

FIG. 2A depicts components of a server in the data center.

FIG. 2B depicts a security module included in the server.

FIG. 2C depicts a software stack for using the security module, in one or more embodiment.

FIG. 3 depicts a flow of operations for securing components of the data center, according to one or more embodiments.

### DETAILED DESCRIPTION

Embodiments described herein provide a way to establish and ensure the continued trustworthiness of a computing environment or data center by making participation of a component in a compute infrastructure conditional upon attestation. In the embodiments, every component (software or hardware) of the infrastructure, such as servers, peripherals, storage and backup, networking and communications equipment, or any other component in or being added to the data center, or the cloud, is verified to be trustworthy using remote attestation technologies. If a particular component is found not to be trustworthy, it is either excluded from the infrastructure, only allowed to perform non-secure operations, or additional precautions will be taken when using the component. For example, before the component is allowed to participate in data center duties, it may be quarantined. In another example, all data handed to the component or passed through the component are encrypted.

Embodiments herein may use a common framework approach to attest components and ensure their trustworthiness. The common framework approach for attestation is, for example, a Trusted Platform Module (TPM), virtualized hardware TPM, and/or hardware (physical) TPM (i.e., a TPM chip). Attestation applies equally to all components, e.g., storage devices, compute and network, virtual machines, peripherals, etc., of the data center or computing environment and presents a consistent and easy way to proactively manage and ensure the security and integrity of the infrastructure of the data center or computing environment to prevent theft of data or data being compromised.

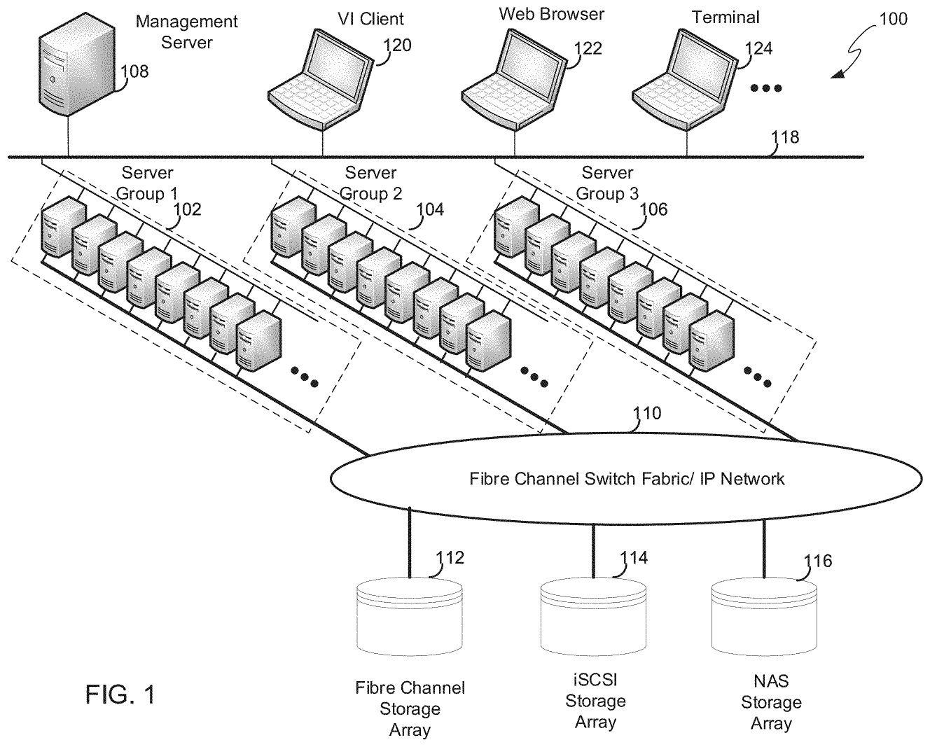

FIG. 1 depicts components in a data center. As shown, the data center 100 includes several groups of servers 102, 104, 106, each server of which is coupled to a main IP network 118 and a storage network switch fabric 110. Included in main IP network 118 and storage network switch fabric 110 are one or more routers and one or more switches coupled to the routers (not shown). Also coupled to main IP network 118 are a management server 108, several user access devices such as a VI (virtual infrastructure) client 120, a web browser device 122, or terminal device 124. One of a Fibre Channel Storage Array 112, an iSCSI storage array 114 or a NAS storage array 116 is coupled to storage network switch fabric 110.

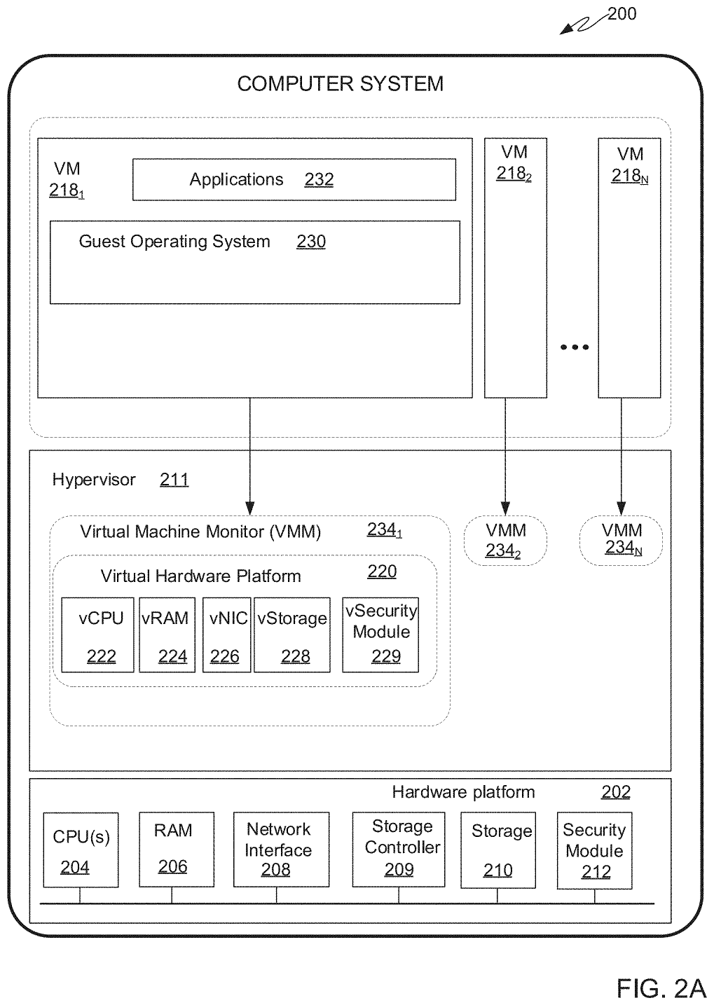

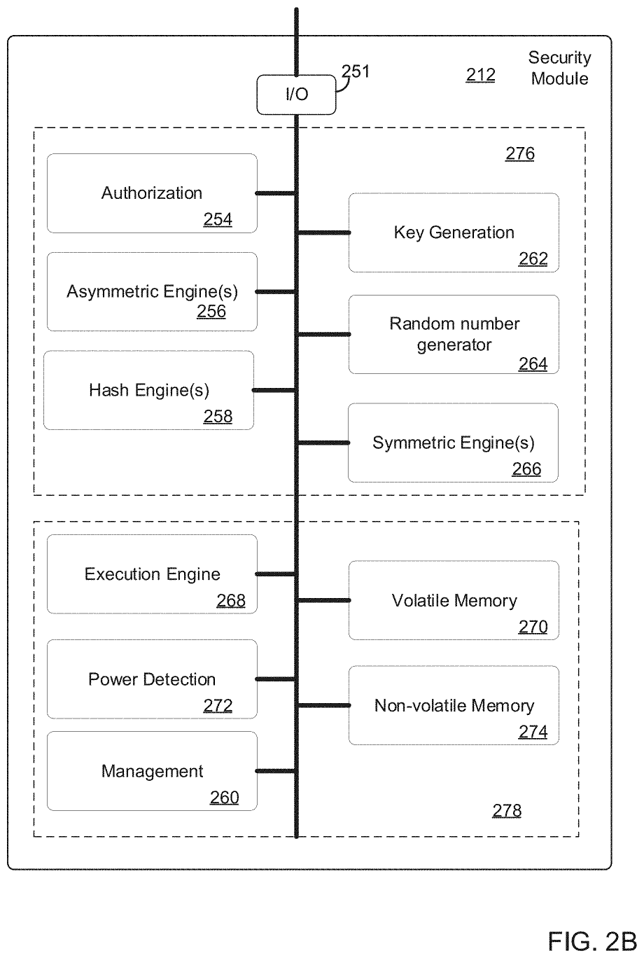

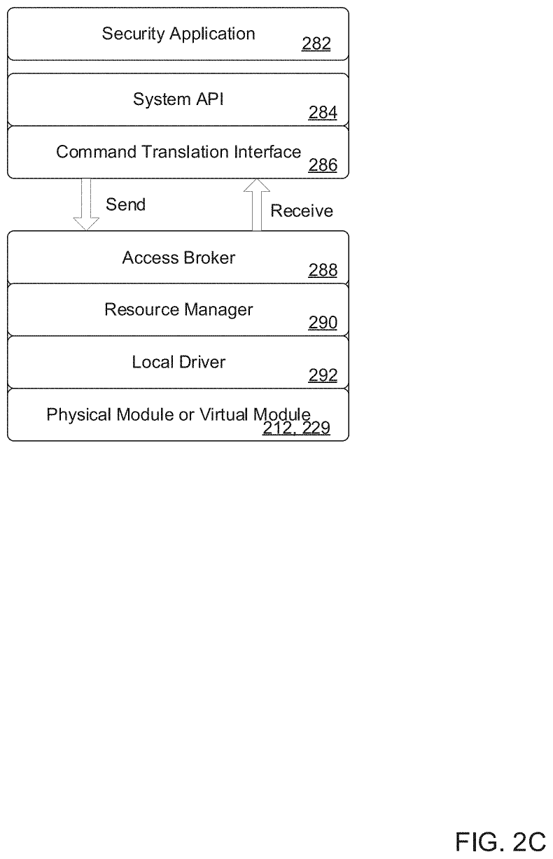

FIG. 2A depicts components of a server (such as those in groups 102, 104, 106, or management server 108) in data center 100, in an embodiment. As is illustrated, computer system 200 hosts multiple virtual machines (VMs) 2181-218N that run on and share a common hardware platform 202.

Hardware platform 202 includes conventional computer hardware components, such as one or more items of processing hardware such as central processing units (CPUs) 204, a random access memory (RAM) 206, one or more network interfaces 208, and persistent storage 210, a storage controller 209 and a physical security module 212.

A virtualization software layer, referred to hereinafter as hypervisor 211, is installed on top of hardware platform 202. Hypervisor 211 makes possible the concurrent instantiation and execution of one or more VMs 218₁-218_{N}. The interaction of a VM 218 with hypervisor 211 is facilitated by corresponding virtual machine monitors (VMMs) 234. Each VMM 234₁-234_{N} is assigned to and monitors a corresponding VM 218₁-218_{N}. In one embodiment, hypervisor 211 may be a hypervisor implemented as a commercial product in VMware's vSphere® virtualization product, available from VMware Inc. of Palo Alto, Calif. In an alternative embodiment, hypervisor 211 runs on top of a host operating system which itself runs on hardware platform 202. In such an embodiment, hypervisor 211 operates above an abstraction level provided by the host operating system.

After instantiation, each VM 218₁-218_{N} encapsulates a physical computing machine platform that is executed under the control of hypervisor 211. Virtual devices of a VM 218 are embodied in a virtual hardware platform 220, which is comprised of, but not limited to, a virtual CPU (vCPU) 222, a virtual random access memory (vRAM) 224, a virtual network interface adapter (vNIC) 226, virtual storage (vStorage) 228 and a virtual security module (vSecurity Module) 229. Virtual hardware platform 220 supports the installation of a guest operating system (guest OS) 230, which is capable of executing applications 232. Examples of a guest OS 230 include any of the well-known commodity operating systems, such as the Microsoft Windows® operating system, and the Linux® operating system, and the like.

It should be recognized that the various terms, layers, and categorizations used to describe the components in FIG. 2A may be referred to differently without departing from their functionality or the spirit or scope of the disclosure. For example, each VMM 234₁-234_{N} may be considered to be a component of its corresponding virtual machine since each VMM 234₁-234_{N} includes the hardware emulation components for the virtual machine. For example, the conceptual layer described as virtual hardware platform 220 is included in the VMM 234₁. Alternatively, each VMM 234₁-234_{N} may be considered separate virtualization components between VM 218₁-218_{N} and hypervisor 211 since there exists a separate VMM for each instantiated VM. Further, though certain embodiments are described with respect to VMs, the techniques described herein may similarly be applied to other types of virtual computing instances, such as containers.

FIG. 2B depicts a security module included in the server. Security module 212 includes, in an embodiment, a first group 276 of hardware blocks that provide security functions or security-related functions and a second group 278 of hardware blocks that run or manage the security or security-related blocks.

Hardware blocks in the first group 276 provide security and security-related functions and include a random number generator (RNG) 264, an asymmetric engine 256, a symmetric engine 266, a hash engine 258, a key generation engine 262, an authorization engine 254.

RNG 264 consists of an entropy source and collector, a state register, and a mixing function. The entropy collector collects entropy from the entropy sources and removes bias. The collected entropy is then used to update the state register providing input to the mixing function to produce random numbers. The mixing function can be implemented with a pseudo-random number generator.

Asymmetric engine 256 provides asymmetric algorithms for attestation, identification, and secret sharing.

Symmetric engine 266 provides symmetric encryption to encrypt some command parameters, and to encrypt protected objects stored outside of security module 212.

Hash engine 258 provides hash functions and is used to provide integrity checking and authentication, as well as one-way functions. Hash engine 258 also implements the Hash Message Authentication Code (HMAC) algorithm.

Key generation engine 262 provides two different types of keys. The first type is produced using the random number generator to seed the computation. The result of the computation is a secret key that is kept in a shielded location. The second type is derived from a seed value and not the RNG 264 directly. The second type of key is based on the use of an approved key derivation function.

Authorization engine 254 is called at the beginning and end of command execution. Before the command is executed, authorization engine 254 checks that proper use of a shielded location is provided. Authorization engine 254 uses hash engine 258 and sometimes asymmetric engine 256.

Hardware blocks in the second group 278 run or manage the security or security-related blocks and include an execution engine 268, volatile memory 270, non-volatile memory 274, management 260, and power detection 272.

Volatile memory 270 holds transient data for security module 212, which is data that is allowed to be lost when security module 212 power is removed.

Non-volatile memory 274 stores persistent state associated with security module 212. Non-volatile memory 274 contains shielded locations. Shielded locations include platform configuration registers (PCRs). One or more PCRs maintain an accumulative hash of log entries that track the events that affect the security state of the platform. Security module 212 can provide an attestation of the value in a PCR, which in turn, verifies the content of the log.

Management 260 manages operational states and control domains of security module 212. The operational states include a power-off state, an initialization state, a startup state, and a shutdown state. The startup state puts security module 212 into an operational state, in which it is ready to receive commands. Control domains determine the entity that controls security module 212.

Execution engine 268 performs commands that are sent to security module 212. Two of the many commands which the security module supports are a PCR_Extend command and a Quote command, which are used in attestation operations. Execution of the PCR_Extend command causes an update to a specified PCR, which is the primary way that PCR values are changed. The PCR_Extend command takes new data stored in a buffer in security module 212, concatenates that data with a hash value (also called a digest) of the specified PCR, applies a hash algorithm to the concatenated data and then stores the hash result into the specified PCR, thus updating the specified PCR. The Quote command computes a digest of a concatenation of values of a selected list of PCRs, and signs the resulting digest.

Power detection 272 detects the power states of security module 212. These states include power on and power off states.

Both groups 276, 278 are coupled to an I/O block 251, which provides access by software external to security module 212.

In some embodiments, the security module 212 is virtualized and provided as a virtual security module 229, as depicted in FIG. 2A.

FIG. 2C depicts a software stack for using the security module, in an embodiment. The layers of the stack include a security application 282, a system API 284, a command translation interface 286, an access broker 288, a resource manager 290, a local device driver 292, and a physical or virtual module 294, such the physical security module 212 or virtual security module 229 in FIG. 2A.

System API 284 provides access to all of the capabilities of security module 212. These include command context allocation, command preparation, command execution, and command completion. Command translation interface 286 is a per-process per security module interface for transmitting and receiving a context structure for security module 212. Access broker 288 is a single-threading interface that allows the sharing of a single security module. Resource manager 290 is a virtual memory manager that swaps out and loads resources so that commands in a current context can operate. Local device driver 292 is the low-level interface to the module that receives a buffer, sends the buffer to physical security module 212, or virtual security module 229, reads a response from the module, and sends the response to the higher layers.

The software stack and the physical or virtual module can be used for several purposes, which include at least: (1) device identification using private keys embedded in the device; (2) encryption of keys, passwords and files; (3) key storage such as for root keys for certificate chains and for endorsement keys used to decrypt certificates; (4) storage for representation of the state of a machine; and (5) storage for decryption keys. In addition, the local device driver may store an event log events in an event log file, which is used to reconstruct and validate PCR values against known values. The local device driver may not only provide storage for the event log files but also provide interfaces to update the log files on PCR extends and access the log files for attestation purposes.

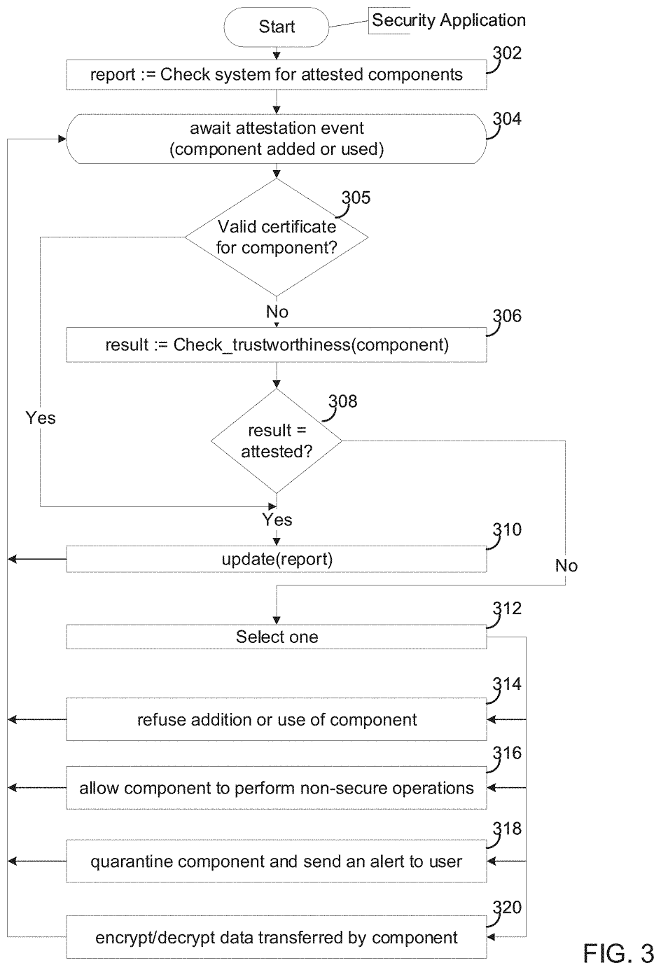

FIG. 3 depicts a flow of operations for a security application, in an embodiment. In step 302, security application 282 checks for attested components and creates a report documenting the check. In step 304, security application 282 awaits an attestation event to be detected by the security application, which recognizes that a component is being added to or newly activated in the current configuration. A component can be detected as being added or newly activated by an explicit configuration change to the data center, such as a user adding or activating a component. Once such an event is recognized, the security application determines, in step 305, whether the component has a signed certificate. If not, the security application proceeds to step 306. Otherwise, the security application proceeds to step 310, which updates the report.

In step 306, security application 282 checks a trust level, which indicates the trustworthiness of the component. In some embodiments, the trustworthiness of the component is checked by using an attestation protocol supported by security module 212. In the attestation protocol, the security application, with the help of the security module carries out, a Quote command, which returns a signed digest of PCRs. After validating the signing key, the security application validates the digest of PCRs by checking that the digest matches previously reported PCR values. The security application then reads an event log (stored by the local device driver) and validates that the event log matches the PCR values. Finally, the security application matches the hashes against a whitelist to determine that the state is secure.]

If the result of the check, as determined in step 308, is that the component is attested then, security application 282 updates the report in step 310 and awaits a new attestation event. If the result of the check is that the component is not attested, then one of several steps is selected in step 312. If step 314 is selected, then security application 282 refuses the addition or use of the component and sends a message to the user, such as an alert in the user's user interface, that the component cannot be added or used. If step 316 is selected, then security application 282 allows the component to run non-secure operations, which are operations that do not require encryption. For example, if a virtual disk is the component being added or activated, then the virtual disk can be used as long as the data on the virtual disk component need not be encrypted. If step 318 is selected, then security application 282, accepts the component but prevents the component from interacting with other components of the data center, and sends a message to the user, such as an alert in the user's user interface, that the component is accepted but not usable (i.e., the component is being quarantined). If step 320 is selected, then security application 282 encrypts and decrypts data transferred by the component. For example, continuing with the example of a virtual disk, security application 282 calls upon security module 212 to encrypt data written to and decrypt data read from the virtual disk rather than relying on the virtual disk to perform these functions.

In some embodiments, steps 316, 318, and 320 are performed with the aid of physical security module 212 or virtual security module 229.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system—computer-readable media may be based on any existing or subsequently developed technology for embodying computer programs in a manner that enables them to be read by a computer.

Examples of a computer-readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer-readable medium can also be distributed over a network coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system level virtualization, wherein an abstraction layer is provided on top of the kernel of an operating system on a host computer. The abstraction layer supports multiple OS-less containers, each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory, and I/O. The term “virtualized computing instance,” as used herein, is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for establishing and maintaining a secure computing infrastructure, the method comprising:
upon an attestation event, checking trustworthiness of a component to be added or activated in the secure computing infrastructure; and
if the checking indicates that the component is not trustworthy, applying one or more security restrictions to the component.

2. The method of claim 1, wherein applying the one or more security restrictions includes:
refusing to add or use the component in the secure computing infrastructure; and
sending a message to a user that the component cannot be installed into the secure computing infrastructure.

3. The method of claim 1, wherein applying the one or more security restrictions includes allowing the component to perform operations that do not involve encryption or decryption.

4. The method of claim 1, wherein applying the one or more security restrictions includes:
accepting the component into the secure computing infrastructure;
preventing the component from interacting with other components in the secure computing infrastructure; and
sending an alert message to a user of the secure computing infrastructure that the component is accepted but not usable.

5. The method of claim 1, wherein applying the one or more security restrictions includes:
encrypting data transferred to or through the component; and
decrypting data received from the component.

6. The method of claim 5, wherein encrypting and decrypting the data is performed with the aid of a security module.

7. The method of claim 6, wherein the security module is a trusted platform module.

8. A system for establishing and maintaining a secure computing infrastructure, the system comprising:
a plurality of servers, the plurality of servers including one or more virtual machines;
a plurality of networks coupled to the servers, the plurality of networks including a storage network; and
a plurality of storage components coupled to the storage network;
wherein when a storage component or a virtual machine is added or used the first time, an application running in the system performs a method comprising:
upon an attestation event, checking trustworthiness of a component to be added or activated in the secure computing infrastructure; and
if the checking indicates that the component is not trustworthy, applying one or more security restrictions to the component.

9. The system of claim 8, wherein applying the one or more security restrictions includes:
refusing to add or use the component in the secure computing infrastructure; and
sending a message to a user that the component cannot be installed into the secure computing infrastructure.

10. The system of claim 8, wherein applying the one or more security restrictions includes allowing the component to perform operations that do not involve encryption or decryption.

11. The system of claim 8, wherein applying the one or more security restrictions includes:
accepting the component into the secure computing infrastructure;
preventing the component from interacting with other components in the secure computing infrastructure; and
sending an alert message to a user of the secure computing infrastructure that the component is accepted but not usable.

12. The system of claim 8, wherein applying the one or more security restrictions includes:
encrypting data transferred to or through the component; and
decrypting data received from the component.

13. The system of claim 12, wherein encrypting and decrypting the data is performed with the aid of a security module.

14. The system of claim 13, wherein the security module is a trusted platform module.

15. A non-transitory computer-readable medium comprising instructions executable in a computer system, wherein the instructions when executed in the computer system cause the computer system to carry out a method for establishing and maintaining a secure computing infrastructure, the method comprising:
upon an attestation event, checking trustworthiness of a component to be added or activated in the secure computing infrastructure; and
if the checking indicates that the component is not trustworthy, applying one or more security restrictions to the component.

16. The non-transitory computer-readable medium of claim 15, wherein applying the one or more security restrictions includes:
refusing to add or use the component in the secure computing infrastructure; and
sending a message to a user that the component cannot be installed into the secure computing infrastructure.

17. The non-transitory computer-readable medium of claim 15, wherein applying the one or more security restrictions includes allowing the component to perform operations that do not involve encryption or decryption.

18. The non-transitory computer-readable medium of claim 15, wherein applying the one or more security restrictions includes:
accepting the component into the secure computing infrastructure;
preventing the component from interacting with other components in the secure computing infrastructure; and
sending an alert message to a user of the secure computing infrastructure that the component is accepted but not usable.

19. The non-transitory computer-readable medium of claim 15, wherein applying the one or more security restrictions includes:
encrypting data transferred to or through the component; and
decrypting data received from the component.
